(19) United States
(12) Patent Application Publication
(10) Pub. No.: US 2024/0160959 A1
(43) Pub. Date: May 16, 2024

(54) SELF-LEARNING QUANTUM COMPUTING PLATFORM

(71) Applicant: Dell Products L.P., Round Rock, TX (US)

(72) Inventors: Victor Fong, Medford, MA (US); Brendan Burns Healy, Haddonfield, NJ (US); Benjamin E. Santaus, Somerville, MA (US)

(21) Appl. No.: 18/345,715

(22) Filed: Jun. 30, 2023

Related U.S. Application Data
(60) Provisional application No. 63/383,336, filed on Nov. 11, 2022.

(51) Int. Cl. G06N 5/022

(52) U.S. Cl. CPC G06N 5/022

(57) ABSTRACT

A method includes predicting, using a machine learning model, runtime characteristics concerning a quantum computing function, predicting, using the machine learning model, resources needed to perform the quantum computing function, selecting an execution environment for the quantum computing function, and executing the quantum computing function in the execution environment. The quantum computing function may be a quantum circuit cutting operation, or the quantum computing function may be a quantum circuit execution.

### FIELD OF THE INVENTION

Some embodiments of the present invention generally relate to quantum computing. More particularly, at least some embodiments of the invention relate to systems, hardware, software, computer-readable media, and methods, for the creation and use of a self-learning quantum computing platform.

### BACKGROUND

Quantum computing (QC) is a rapidly growing field with new algorithms, simulation engines, and hardware actively being developed and made available for consumption. Runtime prediction can provide an intelligent orchestration platform with reasonable accuracy as to runtime characteristics. However, new algorithms, simulation engines, hardware, interested disciplines, and other advancements in the QC field would require intelligent platform providers to re-collect data and re-train machine learning models. Furthermore, new metadata from circuits may also be captured and it can take a significant amount of human resources and effort to introduce the new metadata into existing models.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an architecture according to one example embodiment.

FIG. 2 discloses a method, and some associated elements, according to one example embodiment.

FIG. 3 discloses aspects of an architecture according to one example embodiment.

FIG. 4 discloses a method according to one example embodiment.

FIG. 5 discloses a computing entity configured and operable to perform any of the disclosed methods, processes, and operations.

### DETAILED DESCRIPTION OF SOME EXAMPLE EMBODIMENTS

Embodiments of the present invention generally relate to quantum computing. More particularly, at least some embodiments of the invention relate to systems, hardware, software, computer-readable media, and methods, for a self-learning quantum computing platform.

One example embodiment of the invention comprises the creation and use of an intelligent orchestration platform, or simply “platform” herein, that may be self-learning, so that the platform may be self-optimized even when new advancements in QC are made. An embodiment of the platform may take advantage of its proximity to hardware accelerators. As well, models according to one or more embodiments may be used to predict circuit cutting behavior for various algorithms, as well as the runtime characteristics of each step of circuit cutting, may also be trained and updated with this invention. Note that as used herein, circuit cutting considerations include, but are not limited to, whether or not a quantum circuit, or simply “circuit” herein, can be cut, and if, so, into how many sub-circuits, and the configuration and behavior of any such sub-circuits.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a model used to predict circuit cutting behavior, as well as runtime characteristics of circuit cutting operations, may be trained and updated. An embodiment may use historical information to update and/or retrain models that operate to make predictions regarding circuit cutting behavior. In an embodiment, a new, or updated, model may be automatically deployed to support ongoing circuit submissions. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. General Aspects of Some Example Embodiments

In some conventional approaches, a significant amount of time may be needed to train models to make runtime, and other SLA-based (service level agreement), predictions concerning various operations, one example of which is circuit cutting. The training process, which may take as long as a month in some cases, may include data collection, and training the machine learning model with the data. In contrast, an embodiment of the invention may be effective in reducing the training time for models that operate to make SLA-based, and other, predictions. In one embodiment, runtime prediction may be of particular interest in view of the fact that QPUs (quantum processing units) are priced on a per-second basis and, as such, may be expensive to use.

Further, and continuing with the non-limiting circuit cutting example, because there are many varieties of circuit cutting algorithms, simulation engines and hardware, it is difficult for a platform vendor to pre-train models in a way that enables the models to account for a variety of possibilities. In contrast, an embodiment of the invention may provide an approach, and a model, that is able to dynamically adapt, and/or be dynamically adapted, to new situations, circumstances, and data. In an embodiment, this adaptation may comprise re-training of the model, and may be performed in real time as changes occur in those situations, circumstances, and data.

In a related respect, new algorithms, simulation engines and hardware are frequently made available in the rapidly growing field of QC. However, platform vendors have difficulty obtaining data and keeping up with the new advancements, so runtime prediction may become inaccurate over time. In contrast, the flexibility and adaptability of some embodiments of the invention may be able to accommodate these various and unpredictable changes.

Finally, it may be the case that a user does not wish for the telemetry data concerning a job to leave the premises of the datacenter. Consequently, platform vendors may have difficulties obtaining the telemetry data over time and, accordingly, training new ML (machine learning) models and retraining old models may be difficult or impossible. On the other hand, an embodiment may operate to obtain, in a timely manner, the data needed to train new and existing ML models.

### B. Aspects of an Example Architecture

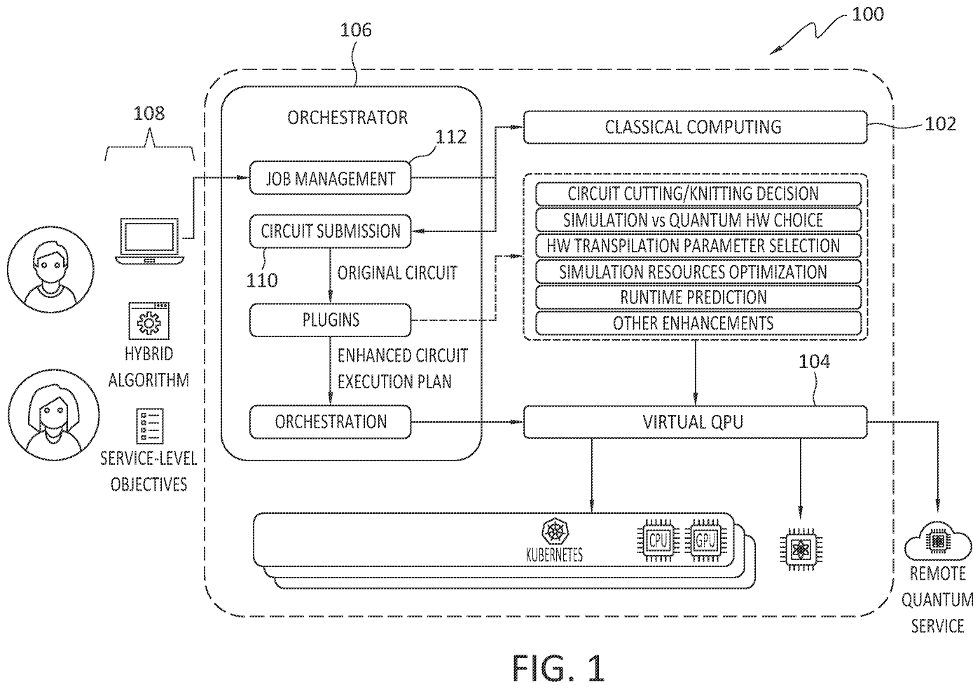

With attention now to FIG. 1, an example architecture according to one embodiment is generally denoted at 100. Briefly, the architecture 100 may comprise a classical computing infrastructure 102 as well as a quantum computing infrastructure 104 that may comprise one or more quantum processing units (QPU), such as real and/or virtual QPUs. An orchestrator platform 106 may use input 108, which may comprise, for example, SLOs (service level objectives), to make orchestration decisions, that is, to decide whether a particular computing job, such as a quantum computing job, will be performed by the quantum computing infrastructure 104, or simulated on the classical computing structure 102. The orchestrator platform 106 may also comprise circuit submission functionality 110, for providing circuits to the computing infrastructure(s) for execution, and job management functionality 112 that manages and monitors the status of submitted computing jobs.

### C. Detailed Discussion of an Example Method, and Associated Components

### C.1 Aspects of an Example Method

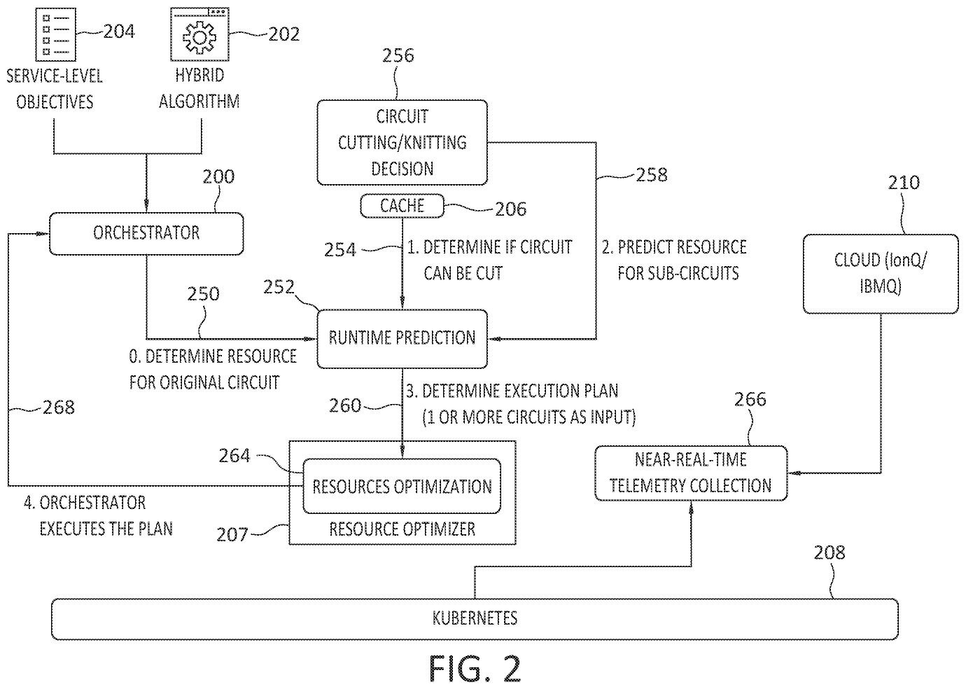

With continued attention to FIG. 1, and directing attention now to FIG. 2 as well, details are provided concerning the operation of an example orchestrator 200 according to one embodiment of the invention. In connection with its operation, the orchestrator 200 may receive various inputs including, but not limited to, a hybrid quantum-classical algorithm 202 that may comprise elements configured to run on one or the other of a classical computing infrastructure and a quantum computing infrastructure, and one or more SLOs 204. For example, inputs such as a hybrid quantum-classical algorithm 202, as well as a quantum algorithm, may comprise one or more quantum circuits that are executable on a quantum computing infrastructure and/or whose execution may be simulated on a classical computing infrastructure.

Initially, and using inputs such as those just described, the orchestrator may determine 250, such as by using an ML model, what computing infrastructure resources would be needed to run the quantum circuit in its original, that is, uncut, form. This determination 250 may involve, for example, making a prediction 252 of the values of various runtime characteristics that may be expected when executing the original circuit. In an embodiment, the predicted runtime characteristic values may be stored in a cache 206.

Next, an ML model of the orchestrator 200 may determine 254 whether or not the original circuit can be cut, and a decision 256 then made, based on the determination 254, as to whether and how, the original circuit can be cut. If the decision 256 is that the original circuit will be cut, then a prediction 258 may be made, such as by the ML model of the orchestrator, as to the computing resources, which may be quantum, classical, or a combination of the two, expected to be needed to perform a circuit cutting process, and/or to run the sub-circuits. Note that even if the decision 256 is not to cut the circuit, the prediction 258 may nonetheless be made.

Given the resources expected to be used for one or more of these processes, a further runtime prediction 260 may be made with respect to the cut circuit. That is, this additional runtime prediction 260, which may be performed by the ML model of the orchestrator, may generate respective predicted values for various runtime characteristics of a circuit cutting process. In an embodiment, predicted values may also be generated for execution of the individual portions, or sub-circuits, of the cut circuit, and may also predict values for the overall, or collective, runtime characteristics of the entire cut circuit.

When the runtime characteristics of a circuit cutting process, and/or execution of the sub-circuits, have been predicted 260, then an execution plan for a circuit cutting process, and/or for the sub-circuits, may be generated 262, such as by the ML model of the orchestrator. In an embodiment, the execution plan, which may be generated using one or more circuits and/or sub-circuits as inputs, may be passed to a resource optimizer 207, which may perform a resources optimization process 264. Further details concerning an example resource optimizer component are disclosed elsewhere herein but, in general, the resources optimization process 264 may identify which computing resources are most optimal, such as in terms of expected runtime characteristics, for performance of the execution plan.

As shown in FIG. 2, the resources optimization process 264 may receive, as an input, near-real-time telemetry collection 266 concerning the execution of one or more circuits, and/or concerning the performance of a circuit cutting process. This input may be used, for example, to inform a determination or identification of which resources are optimal for performance of a circuit cutting process, and/or for execution of one or more circuits and sub-circuits.

Finally, the orchestrator 200 may then carry out 268 the execution plan. In an embodiment, the telemetry collection process 266 may collect telemetry concerning the carrying out 268 of the execution plan. As shown in FIG. 2, telemetry obtained by the telemetry collection process 266 may be obtained from various sources including computing platforms where a circuit and/or sub-circuit may be executed and/or where a circuit cutting process may be performed. Such computing platforms may include, but are not limited to, a platform or environment 208, such as Kubernetes for example, that manages containerized workloads, and a cloud computing environment 210, such as lonQ or IBMQ for example.

### C.2 Further Details Concerning Some Example Components and Operations

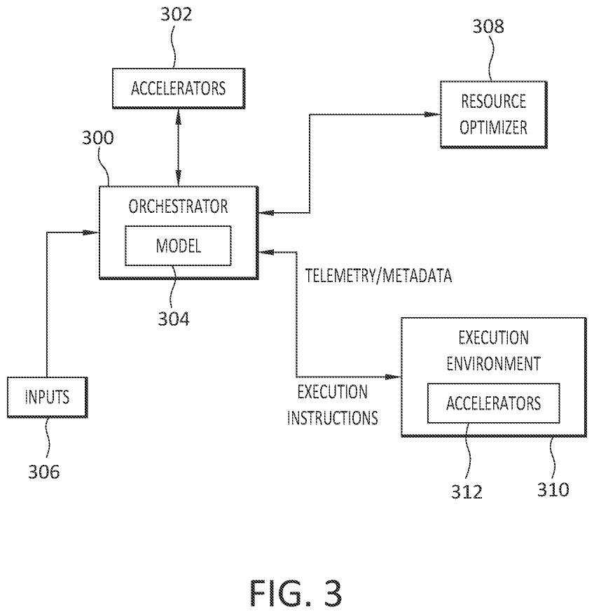

With continued reference to FIGS. 1 and 2, and with attention now to FIG. 3, an orchestrator 300, which may comprise, or be an element of, a self-learning platform, may communicate with various systems, platforms, and components, to perform, and/or cause the performance of, any of the disclosed operations. For example, the orchestrator 300 may have access to computing hardware 302, such as one or more accelerators for example, that may be used to aid in training a model, or models, 304, examples of which are disclosed elsewhere herein. In an embodiment, the orchestrator 300 may perform various operations, such as circuit cutting and/or circuit knitting, and training and/or inferencing of the model 304 for example, that may involve the use of the accelerators.

Operations of the orchestrator 300, including training of the model(s) 304, may be performed using one or more inputs 306 such as, but not limited to, algorithms, simulation engines, hardware information, and SLO objectives. The orchestrator 300 may further communicate with a resource optimizer 308 that may provide information indicating, for example, an optimum quantum hardware configuration for execution of a circuit, or sub-circuit, or a circuit cutting operation.

The orchestrator 300 may execute, or cause the execution of, a circuit, sub-circuit, or circuit cutting operation, in an execution environment 310 which may comprise classical computing infrastructure and/or quantum computing infrastructure. For example, the execution environment 310 may host accelerators 312 for the performance of operations in the execution environment 310. As well, the execution environment 310 may be located on-premises, and/or in a cloud computing environment, and may comprise QPUs and/or vQPUs, for example. As a result of such executions, telemetry may be generated in the execution environment 310 and returned to the orchestrator 300 for use in various processes and operations, including training the model(s) 304.

In one particular embodiment, an orchestrator, such as the orchestrator 106, 200, or 300, for example, may, while executing a circuit, a sub-circuit, or a circuit cutting operation, such as in the execution environment 310 for example, track of any one or more of the following:
1. metadata of each circuit or sub-circuit, including, but not limited to, algorithm used, number of qubits, and circuit depth;
2. the execution environment that the circuits are executed with/in, such as, but not limited to, model of CPU (central processing unit), GPU (graphics processing unit), QPU (quantum processing unit), as well as simulation engine, if used;
3. runtime characteristics based on real-time telemetry, including, but not limited to, execution time, and resources consumed; and
4. real-time, or near real-time, telemetry collection from each of the execution environments may be used, such as queue time, current resource utilization, and others.

Because an embodiment of the orchestrator may have access to many high-powered hardware accelerators, such as GPUs and the other examples noted herein, the orchestrator may use these hardware accelerators to accelerate its learning process. Further, the orchestrator may store training data, and then train with that training data when the load on QPUs or vQPUs (virtual quantum processing unit) is low. QCs may be particularly well suited for ML (machine learning) model training.

Based on data collected over time throughout executions, the orchestrator may periodically submit the dataset of circuit execution to an automated ML framework for training new models of algorithms, simulation engines, and hardware, that have not been pre-trained, or retraining old models, at a time when system resource utilization is low. These new models may then be deployed in an automated manner, so that they can be used for runtime prediction for on-going circuit submissions. The same mechanism of data collection, training, and re-training, of a model, may apply not only to circuit execution, but also to circuit cutting operations, as well as to operations to determine whether or not a circuit can be cut.

Furthermore, when new algorithms and simulation engines and hardware are made available to the orchestrator, the resource optimizer may query the existing dataset to determine which combination is lacking in the dataset. When optimization of resource selection takes place, the optimizer may give learning and data collection a priority, so that while service-level objectives (SLO) are met, the orchestrator may also collect data to further self-learn and self-optimize. If it is within budget, the orchestrator may even use the hardware it is allocating to do the training. Because the orchestrator may already have access to the real time usage data, the orchestrator may do this when job queues are empty and the load is low, to keep costs down, and to increase throughput of the system.

As a non-limiting example, suppose a new hardware, such as NVIDIA A200X GPU, is introduced to the system. If the cost of that new hardware is similar, or within an acceptable range such as about 10 percent, to the cost of an existing GPU (A100), then instead of running on the A100, the resource optimizer, such as the resource optimizer 107, may prioritize execution of the new hardware to obtain runtime telemetry, as shown at 266 in FIG. 2.

### D. Further Discussion

As will be apparent from this disclosure, one or more embodiments may possess various useful features and aspects. A non-exhaustive list of examples of such features and aspects is set forth below. No embodiment is required to comprise any of these features and aspects. Further, these are presented only by way of example and are not intended to limit the scope of the invention in any way.

For example, an embodiment may comprise a self-learning capability for circuit runtime prediction combined with metadata extraction mechanisms.

An embodiment may employ learning as a prioritization factor with resource selection, to prioritize learning across algorithm, simulation engine, and hardware combination, while satisfying SLOs (service-level objectives).

An embodiment may comprise a continuous self-learning capability for circuit cutting predictions, such as whether a circuit can be cut and if so, into how many subcircuits, and runtime characteristics prediction of circuit cutting steps, such as MIP (mixed integer programming) (a set of problems that can be efficiently demonstrated to a classical computer interacting with multiple quantum computers with any amount of shared entanglement between the quantum computers), and result combination, for example. An embodiment may comprise the ability, such as by an orchestrator for example, to use the very resources it is orchestrating, such as when there is low/no external demand for those resources, to train its own models, using overall load-balancing techniques to lower the cost of training the model.

An embodiment may also apply to other workloads such as, but not limited to, deep learning training, or inference. In such cases, the algorithm may be the design of the neural network, and the simulation engine may be a machine learning framework such as Tensorflow for example. The metadata extraction mechanism may extract metadata from DNN (deep neural network) models.

An embodiment may use QPUs (quantum processing units) to train an ML model so as to enhance the ML model responsible for allocating resources, such as the QPUs themselves.

An embodiment may take advantage of live metrics, regarding the resources used to train, as a way of reducing the cost of hiring hardware accelerators, because of how the ML model is uniquely positioned.

As another example, an embodiment may avoid, or eliminate, the need to employ training models that require a long time, up to a month or more, to collect data and train the machine learning model.

As another example, an embodiment may be able to pre-train models that may include a variety of different algorithms, simulation engines and hardware. In an embodiment, some or all pre-training of one or more models may be eliminated. An embodiment may provide reliable and accurate runtime predictions, even in circumstances where new algorithms, simulation engines and hardware are frequently made available in the rapidly growing field of QC. Thus, an embodiment may be able to obtain data, keep up with the new advancements, while still providing accurate runtime predictions.

Finally, an embodiment may enable users to securely retain telemetry data on premises at their datacenter, while still enabling platform vendors to obtain, over time, the data needed to train new ML models, and retrain old models.

### E. Example Methods

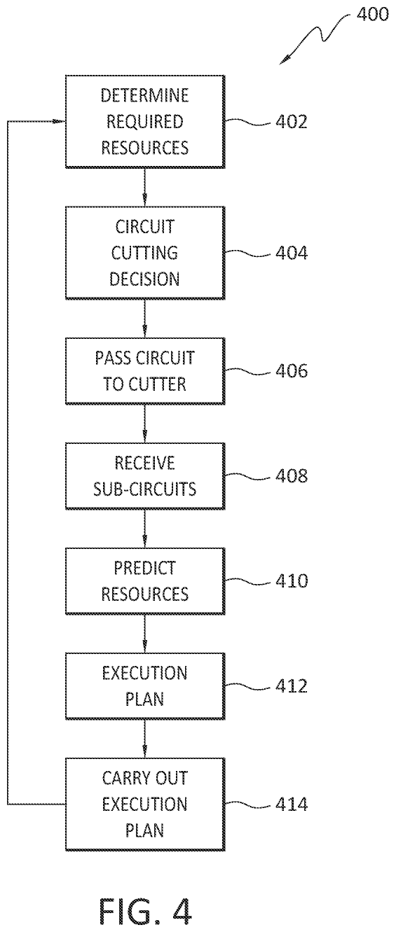

It is noted with respect to the disclosed methods, including the example methods of FIGS. 2 and 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 4, an example method according to one embodiment is denoted generally at 400. In an embodiment, the method 400 may be performed in whole or in part by, and/or at the direction of, an orchestrator. However, no particular functional allocation as amongst the disclosed entities is required.

The example method 400 may begin at 402 where a determination may be made as to what resources, such as memory, storage, or QPUs, for example, would be required to execute an original, or uncut, quantum circuit. The determination 402 may be made based on various considerations such as, but not limited to, the depth of the circuit.

Next, a determination 404 may be made as to whether or not the circuit can be cut into sub-circuits so as to possibly reduce resource consumption and execution time of the circuit as a whole. This determination 404 may be based on various factors. For example, the original circuit may be subjected to a runtime prediction, such as may be performed by an ML model of an orchestrator for example, to determine the amount of resources, execution time, and other factors, that may be implicated by a circuit cutting operation. As well, an orchestrator may also predict, for a possible circuit cutting operation, the success rate, resource consumption and execution time of the cutting mechanisms. In an embodiment, the circuit cutting decision may be informed by telemetry received concerning ongoing circuit cutting, and other, operations, as well as based on inputs received by an orchestrator. Finally, circuit cutting may at least be implied, and possibly required, when adequate quantum computing resources, such as sufficient circuit depth and an adequate number of qubits, are not available to execute the circuit in its original, uncut, configuration. On the other hand, if applicable constraints and requirements can be satisfied without circuit cutting, then it may be preferable, in some embodiments at least, to omit any circuit cutting operation.

If it is determined 404 that the original circuit must be cut, in order to satisfy any constraints and requirements, a component such as an orchestrator may then pass 406 the original circuit to a circuit cutting component and receive 408 the subcircuits if the cutting is successful. Each of the subcircuit may then be passed to a runtime prediction component, which may or may not be an element of the orchestrator, to obtain the runtime characteristics prediction 410.

Based on the prediction 410, a component, such as a resource optimizer, may then select execution environments for each of the subcircuits based on criteria including, but not limited to, service-level objectives, such as time, budget, and accuracy, for example. An execution plan may then be generated 412 by the resource optimizer and returned to the orchestrator to execute 414 the subcircuits in order.

Note that part, or all, of the method 400 may be repeated upon receipt of information including, but not limited to, telemetry, and inputs such as SLOs and algorithms. In such cases, a model used to predict circuit cutting, and/or circuit execution, performance may be updated automatically, and possibly in real time, as such information is received.

### F. Further Example Embodiments

Following are some further example embodiments of the invention. These are presented only by way of example and are not intended to limit the scope of the invention in any way.

Embodiment 1. A method, comprising: predicting, using a machine learning model, runtime characteristics concerning a quantum computing function; predicting, using the machine learning model, resources needed to perform the quantum computing function; selecting an execution environment for the quantum computing function; and executing the quantum computing function in the execution environment.

Embodiment 2. The method as recited in any preceding embodiment, wherein the quantum computing function comprises a circuit cutting process.

Embodiment 3. The method as recited in any preceding embodiment, wherein the quantum computing function comprises a quantum circuit execution.

Embodiment 4. The method as recited in any preceding embodiment, wherein telemetry concerning execution of another quantum computing function is used by the machine learning model to retrain itself.

Embodiment 5. The method as recited in any preceding embodiment, wherein metadata and runtime characteristics relating to the quantum computing function are collected from the execution environment while the quantum computing function is being executed.

Embodiment 6. The method as recited in any preceding embodiment, wherein the predicting of the runtime characteristics and/or the predicting of the resources, by the machine learning model, are performed based on inputs comprising any one or more of hybrid algorithm, service level objective, simulation engine, and available hardware.

Embodiment 7. The method as recited in any preceding embodiment, wherein the resources are used to retrain the machine learning model when demand for those resources permits.

Embodiment 8. The method as recited in any preceding embodiment, wherein the quantum computing function comprises a circuit cutting process, and the runtime characteristics concerning the circuit cutting process comprise a prediction as to how many sub-circuits can be created from a circuit that is a subject of the circuit cutting process.

Embodiment 9. The method as recited in any preceding embodiment, wherein the quantum computing function comprises a circuit cutting process, and the predicting of the runtime characteristics comprises predicting that the circuit cutting process can be performed.

Embodiment 10. The method as recited in any preceding embodiment, wherein the machine learning model is trained in real-time as telemetry is received concerning execution of another quantum computing function.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers or annealing devices, gate-based quantum devices such as in the form of a quantum circuit, qbits, and real quantum hardware. Other hardware comprises a simulation engine, such as a simulated annealing device, that simulates actual hardware and is operable to obtain a resolution to a problem such as a QUBO for example. Other annealers or annealing devices may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

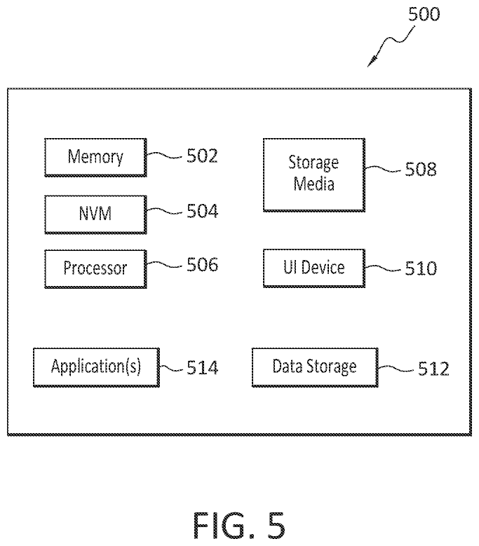

With reference briefly now to FIG. 5, any one or more of the entities disclosed, or implied, by FIGS. 1-5, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
predicting, using a machine learning model, runtime characteristics concerning a quantum computing function;
predicting, using the machine learning model, resources needed to perform the quantum computing function;
selecting an execution environment for the quantum computing function; and
executing the quantum computing function in the execution environment.

2. The method as recited in claim 1, wherein the quantum computing function comprises a circuit cutting process.

3. The method as recited in claim 1, wherein the quantum computing function comprises a quantum circuit execution.

4. The method as recited in claim 1, wherein telemetry concerning execution of another quantum computing function is used by the machine learning model to retrain itself.

5. The method as recited in claim 1, wherein metadata and runtime characteristics relating to the quantum computing function are collected from the execution environment while the quantum computing function is being executed.

6. The method as recited in claim 1, wherein the predicting of the runtime characteristics and/or the predicting of the resources, by the machine learning model, are performed based on inputs comprising any one or more of hybrid algorithm, service level objective, simulation engine, and available hardware.

7. The method as recited in claim 1, wherein the resources are used to retrain the machine learning model when demand for those resources permits.

8. The method as recited in claim 1, wherein the quantum computing function comprises a circuit cutting process, and the runtime characteristics concerning the circuit cutting process comprise a prediction as to how many sub-circuits can be created from a circuit that is a subject of the circuit cutting process.

9. The method as recited in claim 1, wherein the quantum computing function comprises a circuit cutting process, and the predicting of the runtime characteristics comprises predicting that the circuit cutting process can be performed.

10. The method as recited in claim 1, wherein the machine learning model is trained in real-time as telemetry is received concerning execution of another quantum computing function.

11. A non-transitory storage medium having stored therein instructions that are executable by one or more hardware processors to perform operations comprising:
predicting, using a machine learning model, runtime characteristics concerning a quantum computing function;
predicting, using the machine learning model, resources needed to perform the quantum computing function;
selecting an execution environment for the quantum computing function; and
executing the quantum computing function in the execution environment.

12. The non-transitory storage medium as recited in claim 11, wherein the quantum computing function comprises a circuit cutting process.

13. The non-transitory storage medium as recited in claim 11, wherein the quantum computing function comprises a quantum circuit execution.

14. The non-transitory storage medium as recited in claim 11, wherein telemetry concerning execution of another quantum computing function is used by the machine learning model to retrain itself.

15. The non-transitory storage medium as recited in claim 11, wherein metadata and runtime characteristics relating to the quantum computing function are collected from the execution environment while the quantum computing function is being executed.

16. The non-transitory storage medium as recited in claim 11, wherein the predicting of the runtime characteristics and/or the predicting of the resources, by the machine learning model, are performed based on inputs comprising any one or more of hybrid algorithm, service level objective, simulation engine, and available hardware.

17. The non-transitory storage medium as recited in claim 11, wherein the resources are used to retrain the machine learning model when demand for those resources permits.

18. The non-transitory storage medium as recited in claim 11, wherein the quantum computing function comprises a circuit cutting process, and the runtime characteristics concerning the circuit cutting process comprise a prediction as to how many sub-circuits can be created from a circuit that is a subject of the circuit cutting process.

19. The non-transitory storage medium as recited in claim 11, wherein the quantum computing function comprises a circuit cutting process, and the predicting of the runtime characteristics comprises predicting that the circuit cutting process can be performed.

20. The non-transitory storage medium as recited in claim 11, wherein the machine learning model is trained in real-time as telemetry is received concerning execution of another quantum computing function.
